(19) United States
(12) Patent Application Publication
(10) Pub. No.: US 2019/0068455 A1
(43) Pub. Date: Feb. 28, 2019

(54) System and Method for IoT Device Signal Simulation

(71) Applicant: Artis Consulting, L.P., Richardson, TX (US)

(72) Inventor: Joseph Randolph, Lucas, TX (US)

(73) Assignee: Artis Consulting, L.P., Richardson, TX (US)

(21) Appl. No.: 16/119,755

(22) Filed: Aug. 31, 2018

Related U.S. Application Data
(60) Provisional application No. 62/552,992, filed on Aug. 31, 2017.

(51) Int. Cl. H04L 12/24; G06F 17/50; H04L 29/08

(52) U.S. Cl. CPC H04L 41/145; H04L 67/12; G06F 17/5009

(57) ABSTRACT

Systems and methods of improving the operation of an internet-of-things device signal simulation system are disclosed. Implementing a reliable actor model, a multitude of devices and/or sensors of an internet-of-things system may be simulated and may generate realistic data streams for delivery to an internet-of-things system and/or for analysis to confirm proper system functioning prior to final implementation. The efficiency and resiliency of the internet-of-things device and system may be enhanced and the test data may be improved, so that the final implementation more properly functions according to approved parameters, as well as the bandwidth and processor load associated with the simulation ameliorated. Moreover, the simulation system may source data to a real hardware system and vice versa.

### RELATED APPLICATIONS

This application claims the benefit of and priority from U.S. Provisional Patent Application Ser. No. 62/552,992, entitled “System and Method for Digital Signal Simulation,” filed Aug. 31, 2017, and naming Joe Randolph as inventor, the entirety of which is incorporated by reference herein for all purposes.

### FIELD

The present disclosure relates to device simulation and data analytics for internet of things systems.

### BACKGROUND

Large data sets may exist in various sizes and with various levels of organization. In various instances, large data sets are associated with signals propagating within an internet-of-things system. In various instances, relationships among signals are very complex. Moreover, large data sets are associated with real world aspects of the context environment in which an internet-of-things device operates. In various instances, these data sets are too large to permit simulation of an internet-of-things system due to the severe network congestion and electronic processor load associated with creating realistic inputs and outputs for internet-of-things devices as well as simulating the behavior of the devices in response to the inputs and outputs. Yet further, such congestion and processor load tremendously inhibits any ability to drive hardware devices, such as all or part of an internet-of-things device, system, or network, with realistic inputs and outputs to simulate operating conditions or changes to the device, system, or network, due to the network congestion and electronic processor load associated therewith. These limitations hamper the availability of realistic testing of internet-of-things devices, systems, and networks prior to the actual construction and implementation of a hardware system and concurrent reliance on the same to function properly.

### SUMMARY

The forgoing features and elements may be combined in various combinations without exclusivity, unless expressly indicated herein otherwise. These features and elements as well as the operation of the disclosed embodiments will become more apparent in light of the following description and accompanying drawings.

An IoT device signal simulation system is provided. The system may include a context environment modeling platform, a simulation execution platform, and a reliable actor instantiation system. The context environment modeling platform may be configured to develop an electronic representative model of a plurality of sensor inputs to simulated sensors associated with a simulated device in a context environment. The simulation execution platform may be configured to develop an electronic representative model of an operating IoT system ingesting the plurality of sensor inputs and creating a plurality device outputs associated with the simulated device in the context environment. The reliable actor instantiation system may be operative to generate the electronic representative models in response to at least one of the context environment modeling platform and the simulation execution platform.

In further instances, an IoT device simulation system including a context environment modeling platform with a model management partition and a simulation management partition is provided. The IoT device simulation system may also include a simulation execution platform and a reliable actor instantiation system. The context environment modeling platform may be configured to develop an electronic representative model of a plurality of sensor inputs to sensors associated with a device in a context environment. The model management partition may include a things library including a cloud-sourced repository of at least one a device model of a device and a sensor model of a sensor. The simulation management partition may include a simulation management database to provide a simulation. The simulation execution platform may be configured to develop an electronic representative model of an operating IoT system including at least one of the device and the sensor, the simulation execution platform ingesting the sensor inputs and creating device outputs associated with the at least one of the device and the sensor in the context environment responsive to the simulation. The reliable actor instantiation system may be operative to generate the electronic representative models in response to at least one of the context environment modeling platform and the simulation execution platform.

A simulation engine is provided. The simulation engine may include a sensor reliable actor service module configured to instantiate sensors via a reliable actor instantiation system. The engine may include device reliable actor service module configured to instantiate devices via the reliable actor instantiation system and to send signals generated by the instantiated sensors and data representative of a device status to a state machine service module via a simulation engine bus. Moreover, the engine may include a provisioning engine operable to transmit a call to the reliable actor instantiation system via an I/O controller connected to the simulation engine bus, the call including an instruction to instantiate the instantiated devices or the instantiated sensors. Furthermore, the engine may have a state machine service module configured to direct an operation of the device reliable actor service module and the sensor reliable actor service module including triggering state transitions for at least one of the instantiated devices and the instantiated sensors in response to the signals and the device status, wherein, in response to the state transition indicating an off state of at least one of the instantiated sensors, the state machine service module blocks data to the at least one of the instantiated sensors from the simulation engine bus. The engine may have a telemetry engine connected to the device reliable actor service module via the simulation engine bus and configured to format a signal from at least one of the instantiated devices and the instantiated sensors for delivery to an IoT hub of a simulation client instance of a simulation environment. Finally, the engine may have a stream analytics engine configured to capture data between at least one of the at least one of the instantiated devices and the at least one of the instantiated sensors and the IoT hub of the simulation client instance of the simulation environment and create a user readable visualization of the data.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates an abstracted exemplary system illustrating various data flows between aspects of context environment modeling platform including a simulation execution platform of a IoT device signal simulation system, in accordance with various embodiments;

FIG. 2 illustrates an abstracted exemplary system for reliable actor instantiation by the IoT device signal simulation system, in accordance with various embodiments;

FIG. 3A-B illustrates an example system architecture of an implementation of the IoT device signal simulation system according to FIG. 1, in accordance with various embodiments; and

FIG. 4 illustrates aspects of a simulation engine of the system architecture of the implementation of the IoT device signal simulation system according to FIG. 3A-B.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Advances in technology have led to an increasingly networked world of electronic devices including sensors and effectors both sensing aspects of the surrounding environment (“context environment”) and effecting aspects of the surrounding environment (also, “context environment”). The burgeoning network of physical objects, such as devices, vehicles, buildings, and other items, embedded with electronics, software, sensors, and network connectivity enables the objects to collect and exchange data. Moreover, data collected from the distributed array of physical objects is subject to collection, storage and analysis such as to ascertain conditions of a context environment through sensors, or to change the conditions of a context environment through effectors. This burgeoning network is often subject to bandwidth limitations, for instance, being comprised of power-efficient devices with limited capabilities. Moreover, the limitations of the devices and features of the devices frequently cause networks, network connections, and network bandwidth demands to scale non-linearly, such that there is a need for testing and simulation of networks of connected internet-of-things devices so that the proper sensor-effector interactions with the environment are confirmed and the capacity of the system to operate properly in view of bandwidth and processing power limitations may be confirmed. Such testing frequently demands the emulation of significant amounts of data mimicking expected data that would be generated by an internet-of-things system when implemented in a context environment. Various aspects of such data are interrelated, serving as independent and dependent variables interconnected with linear and non-linear relationships often characterized by hysteresis and asymptotic behaviors. As such, simulation or modeling is often associated with bandwidth and processor loads exceeding that available for real-time simulation or for on-the-fly testing and reconfiguration of simulated systems.

Moreover, simulation or modeling potentially associated with bandwidth and processor loads exceeding that available may give rise to both hardware or software problems, such as during a prototyping phase and may exacerbate costs and limitations related to potential overbuilding of devices, both logical, and physical, in response to bandwidth and processor loads, as well as other limitations.

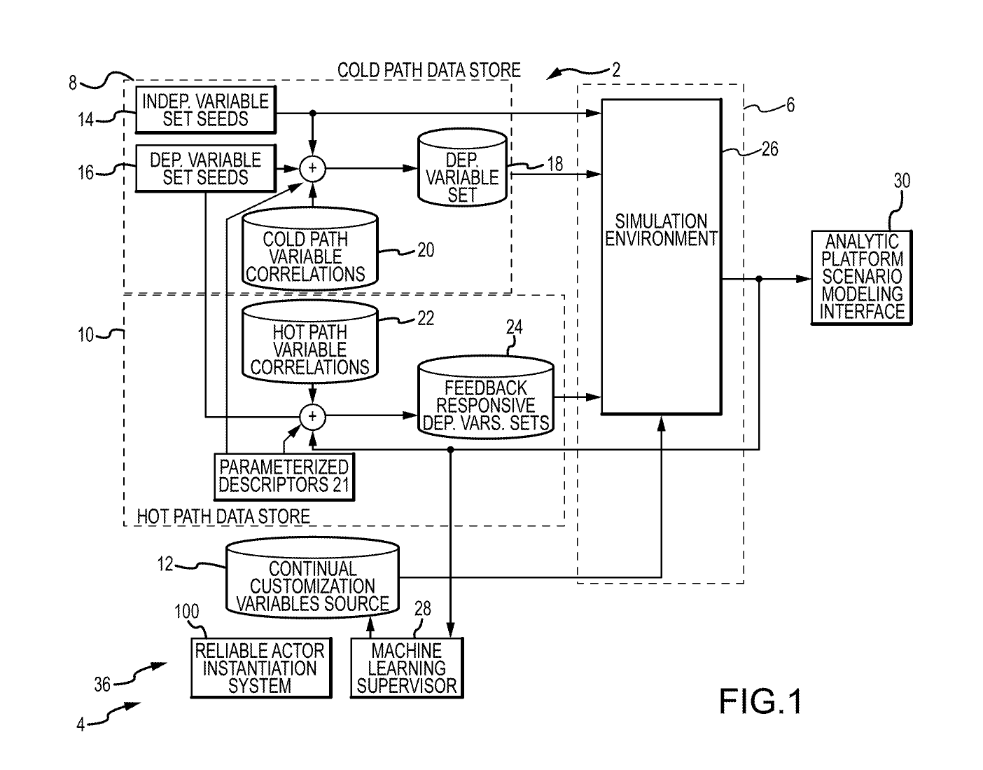

In view of the serious bandwidth, processor speed, and other limitations, a need arises for a system and method for internet of things device signal simulation. In various embodiments, the provisioning of virtualized scenarios facilitates quick and cost-effective evaluation of IoT network architectures and interoperability between IoT aspects as networks scale. For instance, an environment at a device may be modeled, including aspects such as signal level, device onboarding, device management, sensor inputs, sensor outputs, effector inputs, effector outputs, and modeling of sensor-to-effector interactions. Furthermore, expected output values such as independent and dependent variables may be modeled, as may the correlations and dependencies there among and the types and ranges of such variables may be modeled, so that the IoT device signal simulation system 2 (see FIGS. 1-4) is adaptable to configuration to emulate a variety of different devices, networks, and context environments as desired. For example, a common framework may be provided for IoT device signal simulation for temperature sensing networks for industrial freezer applications, as may also be provided for cellular telephone telemetry data networks for distributed industrial appliances such as oil and gas production systems, among other examples, as one may appreciate. The system may generate responsive data based on a combination of an electronic representative model of a device and also device outputs associated with the device in a context environment.

Such a system further facilitates incorporation of multiple streams of information, such as from different sensors producing data of differing types, and expected data streams of information providable to different sensors, such as base commands, custom commands such as extensible custom commands, etc. For instance, base commands may include commands applicable to any electronic device, such as a reset command. A custom command may include context environment specific commands that provide for more realistic models and/or simulations.

Yet furthermore, such multiple streams of information may also include external data, such as to decorate models, including from a catalog of devices and sensors (e.g., “things”) discussed further herein. For instance, a matching (in contrast to analytic—which is discussed further herein) data set may further improve realism of models and simulations.

In various instances, complementary data streams also provide useful input for the modeling of the context environment and thus modeling of data to be provided to aspects to the IoT device signal simulation system 2 (see FIGS. 1-4). For example, third party or public data sources may be implemented such as weather data, stock data, time data, photographs, such as images of sensors and devices, and the like.

Thus, one may appreciate that a configurable and repeatable simulation system drawing from a catalog of devices and sensors (e.g., “things”) crowd sourced over time and from many may be provided. The system may develop signals for provision to/from the sensors and devices of the IoT device signal simulation system 2, (see FIGS. 1-4) relying on statistical distributions associated with real-life hardware implementations. This may improve the functioning of the simulations. Moreover, by providing for reliable actor instantiation, network bandwidth and processor demands are ameliorated as a user may refine device types and configuration, telemetry frequency and volume, re-run simulations as needed to confirm and change assumptions, and optimize complex interdependent systems via simulation. There may be generated both historical and current real-time data so that the same model may, via a simulation, provide a time lapse of time-series data, enhancing simulations. Yet further, concurrent execution, such as the parallelization of multiple models and/or multiple simulations, which in various instances is controllable via a simulation management aspect discussed elsewhere herein, facilitates concurrent experiments/scenarios executed in a batched fashion, addressing practical hardware, software, memory, processor power, and other limitations.

One may also appreciate the implementation of a versatile statistical data generation in connection with the development of realistic data streams (signals) having statistical distributions. For instance, numeric data may be generated with custom signal signatures such as having customized monotonic changes, duty cycles, degradation, and the like. Similarly, enumerated data may be generated with custom signal signatures, such as including a defined list of values described via a state machine based on probability determinism. Yet furthermore, location data may be provided such as a compound data type based on both a numeric and enumeration that enables multiple coordinate mapping systems to support both global and/or relative positioning. This supports location-based services including but not limited to geofencing.

As a consequence, it becomes possible that analytics generates data sets, rather than data generating analytics, such that the data sets representing the architecture of an IoT device network and the data flowing into and out of the IoT device network are accurate and configurable, while the reliable actor design pattern facilitates real-time implementation, and massive scaling in view of contemporary processor power and network bandwidth/congestion considerations. As used herein, an IoT device network may include all or a portion of an IoT device signal simulation system 2 (see FIG. 1) and may include other aspects as desired.

With reference now to FIGS. 1-4, but particular reference to FIG. 1, an IoT device signal simulation system 2 is provided. In various instances, an IoT device signal simulation system 2 comprises an electronic system configured to model sensors and devices, and to model realistic input and output data flowing between aspects of the sensors and devices and from the context environment. For example, realistic temperature data may be provided to a modeled sensor based on the expected context environment, such as a commercial freezer. In various instances, third party data, such as weather data may be ingested and/or modeled. Third party data, such as weather data may be used such that the operation of a commercial freezer located in a cold climate may be modeled and compared to operation of a commercial freezer located in a warm climate. Thus, the realism of the data generated may facilitate development of proposed system architectures, for real life implementations, and yet via the systems and methods disclosed herein, address bandwidth and processor power limitations contemporarily associated with generating realistic data streams representative of inputs and outputs for a context environment, then generating sufficient sensors, devices, and/or simulated hardware to represent a realistic IoT device system implementation, which may comprise thousands or more sensors and devices.

Without sufficient sample size scale, it can be impossible to recognize and remediate architectural bottlenecks and limitations. Because these solutions go through many iterations, it may desirable to model sufficient use cases to obtain sufficient patterns to build predictive and descriptive models. For example, to model a store and more specifically, to model/track beverage consumption from coolers in a store, models may be prepared in relation to rearranging beverage products, but such results of simulations associated with such models may provide only some of the relevant predictive information, for instance, location or demographics data may also be associated with beverage consumption and or the correlation of beverage consumption to beverage location. As a consequence, models contemplating a variety of channels, such as category, class, location, etc. of stores may be desired to be modeled. Resultantly, tremendous sample size scale may be associated with a practical implementation of an IoT device signal simulation system 2.

In various instances, an IoT device signal simulation system 2 comprises a context environment modeling platform 4. A context environment modeling platform 4 comprises a collection of logical devices operable by a processor in a non-transient computer readable memory and is configured to develop an electronic representative model of relevant sensor inputs and outputs expected due to ambient conditions, nominal operating conditions, and abnormal operating conditions for aspects of an IoT system (e.g., expected in a “context environment”).

Moreover, an IoT device signal simulation system 2 comprises a simulation execution platform 6. A simulation execution platform 6 comprises a collection of logical devices operable by a processor in a non-transient computer readable memory and is configured to develop an electronic representative model of an operating IoT system ingesting inputs and creating outputs expected due to ambient conditions, nominal operating conditions, and abnormal operating conditions for aspects of an IoT system.

Thus one may appreciate that modeling a context environment and then executing a simulation may occur simultaneously, synchronously, or asynchronously as desired due to the partitioning of the IoT device signal simulation system 2 into a context environment modeling platform 4 and a simulation execution platform 6. Each of the context environment modeling platform 4 and the simulation execution platform 6 may comprise a set of simulated devices, sensor and the like. For example, within a context environment modeling platform 4 there may be a given context environment that may comprise thousands of sensors. Similarly, within a simulation execution platform 6, there may be a given IoT system that has thousands of inputs, such as thousands of sensors, each of which it is desired to receive unique data streams, such as unique temperature over time data.

The IoT device signal simulation system 2 may also include an analytic platform scenario modeling interface 30. The analytic platform scenario modeling interface 30 may include an automated, manual, or partially automated system aspect interconnected to the simulation execution platform 6 and facilitating at least one of control of the simulation execution platform 6 and receipt from the simulation execution platform 6 of outputs for user review, further automated or manual analysis, and for user consumption.

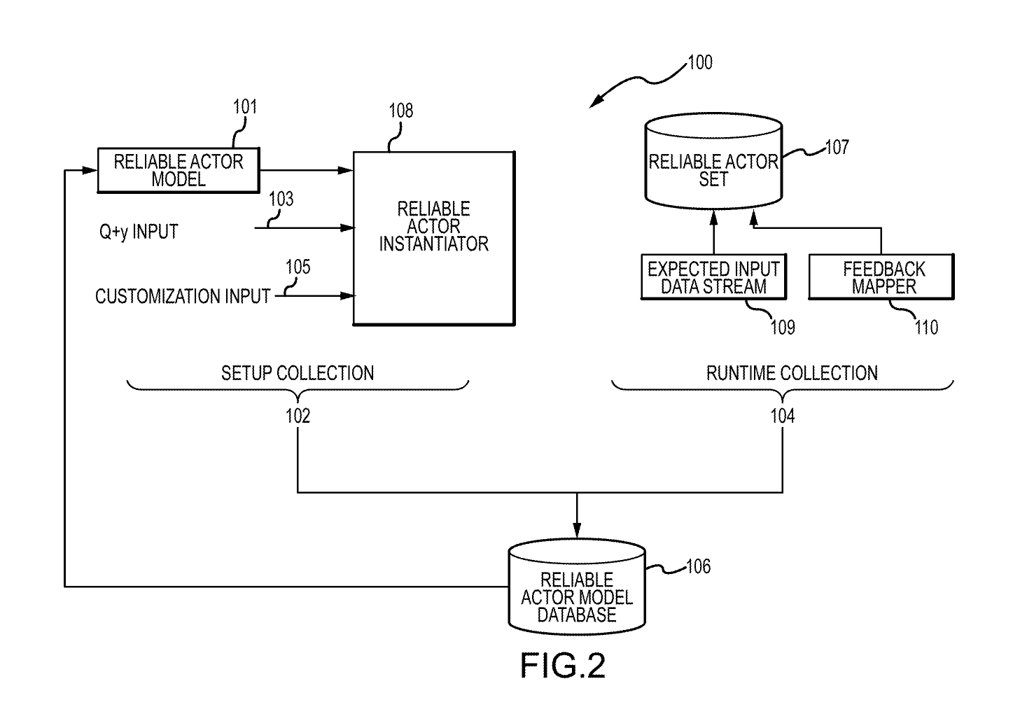

With particular emphasis on FIGS. 1 and 2, the IoT device signal simulation system 2 further comprises a reliable actor instantiation system 100. Operative to configure both the context environment modeling platform 4 and the simulation execution platform 6, the reliable actor instantiation system 100 comprises a collection of logical devices operable by a processor in a non-transient computer readable memory and is configured to develop an electronic representative model of a device and/or a sensor of the IoT device signal simulation system 2 that operates according to defined rules, having a known transfer function among inputs and outputs. In this manner, the massive network of devices and signals and sensors to be modeled and to be simulated is reliably operable due to the self-contained modular architecture of each sensor, device, or the like (collectively, each “actor”) instantiated by the reliable actor instantiation system 100.

Having provided a general overview of aspects of the IoT device signal simulation system 2, specific emphasis is now directed to aspects of the context environment modeling platform 4 therein. With emphasis on FIG. 1, the context environment modeling platform 4 may comprise a cold path data store 8 and a hot path data store 10. The context environment modeling platform 4 may also comprise a contextual customization variables source 12 and a machine learning supervisor 28.

The cold path data store 8 may comprise a storage and processing facility for data which, in various embodiments, is provided to/from aspects of a sensor, device, or other aspect of an IoT system which changes with relative infrequency, such as not varying during a typical run-time duration of a typical scenario to be simulated by a simulation execution platform 6. For example, in various instances, temperature data generally associated with the current season of the year may be cold path data associated with the cold path data store 8, whereas, as will be discussed below, temperature data associated with the minute-to-minute internal conditions of an industrial freezer may be hot path data associated with the hot path data store 10. In various instances, cold path data does not change during execution (e.g., at runtime) of a simulation run by a simulation execution platform 6.

The hot path data store 10 may comprise a storage and processing facility for data which, in various embodiments, is provided to/from aspects of a sensor, device, or other aspect of an IoT system which changes with relative frequency, such as significantly varying during a typical run-time duration of a typical scenario to be simulated by a simulation execution platform 6. For example, in various instances, temperature data generally associated with the minute-to-minute internal conditions of an industrial freezer may be hot path data associated with the hot path data store 10. In various instances, hot path data does change during execution (e.g., at runtime) of a simulation run by a simulation execution platform 6, and thus its modeling exerts greater processor and bandwidth demand on an IoT device signal simulation system 2 which may be resolved via use of the reliable actor instantiation system 100 (FIG. 2) and the asynchronous generation of cold path data by the context environment modeling platform 4 lessening such loads during emulation execution by the simulation execution platform 6.

The context environment modeling platform 4 may also include a contextual customization variables source 12. In various instances, while there may be an advantageous generation of both hot path and cold path data via the hot path data store 10 and cold path data store 8, there may be a beneficial variation of input data streams during simulation run time, such as by a user adjusting the simulation to monitor effects of different adjustments. Furthermore, there may be customizations desired to be made to models of devices, sensors, and other IoT component system which change the transfer function of the devices, sensors, and other IoT components when receiving input data, producing outputs, and feeding back outputs to inputs or otherwise interlinking data streams in a practical system. As such, in various instances a context environment applied to an IoT system may make reuse of previously developed hot path and cold path data, and may further involve the generation of difference data, e.g., customization data that represents variations of the instant system, devices, sensors, and other IoT components from a previously developed model. The contextual customization variables source 12 may source such difference data and for mixing with hot path and cold path data to drive a simulation by the simulation execution platform 6, while ameliorating bandwidth and processor demands during simulation such as by diminishing the amount of calculation required for data generation at run time.

Finally, the machine learning supervisor 28 may monitor the output data generated by a simulation environment 26 and may make responsive adjustments to the operation/data of the hot path data store 10 and/or the contextual customization variables source 12. In this manner, the inputs received by the simulation environment 26 from the context environment modeling platform 4 may be adapted by machine learning based on learned patterns. For instance, a transfer function of the simulation environment 26 may be modeled and progressively improved based on the changing response of outputs from the simulation environment 26 in response to the changing inputs to the simulation environment 26. In this manner the context environment modeling platform 4 may adapt models based on previous models, learning over time.

Having provided a general overview of aspects of the IoT device signal simulation system 2, and the context environment modeling platform 4, specific emphasis is now directed to aspects of the simulation execution platform 6. With emphasis on FIG. 1, the simulation execution platform 6 may include a simulation environment 26.

A simulation environment 26 may comprise a collection of logical devices operable by a processor in a non-transient computer readable memory configured to apply data streams to an electronic representative model of an operating IoT system. The simulation environment 26 is also operable to generate output data in response to the operation of the logical devices according to their operative parameters and characteristics. Thus, the simulation environment 26 creates outputs representative of those that would be produced by an implementation of the simulated IoT system.

Having provided a general overview of aspects of the IoT device signal simulation system 2, the context environment modeling platform 4, and the simulation execution platform 6, attention is returned to subsystems of the context environment modeling platform 4. Specifically, attention is turned first to the cold path data store 8, and later the hot path data store 10.

With respect to the cold path data store 8, various logical partitions are contemplated. For instance, the cold path data store 8 comprises independent variable set seeds 14. The independent variable set seeds 14 comprise an array of values associated with expected variable values for an independent variable of a context environment. For instances, the independent variable set seeds 14 comprise seeds to generate a data stream that would be expected by an IoT system in a real world environment. For instance, temperature, or wind speed might be independent variables because they are not responsive to the operation of the IoT system nor are they responsive to the measure of another variable. Such independent variable set seeds 14 may be used by a simulation environment 26 to simulate operation of an IoT system if it were placed in a location having such a temperature, or wind speed or other aspect of a context environment.

The cold path data store 8 may also comprise dependent variable set seeds 16. For instance, the dependent variable seeds comprise an array of values associated with expected variable values for a dependent variable of a context environment. For instance, the dependent variable set seeds 16 comprise seeds to generate a data stream that would be expected by an IoT system in a real world environment wherein the IoT system was in receipt of the input variables based on the independent variable set seeds 14. For instance, the electrical consumption of an industrial freezer in a context environment having a temperature or wind speed provided by an independent variable set seed 14 may be a dependent variable associated with such a context environment.

The cold path data store 8 may further comprise a cold path variable correlations database 20. A cold path variable correlations database 20 may comprise representations of a function linking the dependent variables associated with the dependent variable set seeds 16 to the independent variables. In other words, the cold path variable correlations database 20 comprises the correlations relating dependent variables to independent variables.

Thus, one may appreciate that the combination of independent variable set seeds 14 with dependent variable set seeds 16 as well as data from the cold path variable correlations database 20 may be ingested by a function to produce dependent variables sets which are stored in a dependent variable sets database 18.

A dependent variable sets database 18 comprises a database of values of dependent variables over time, properly correlated to the independent variables of the context environment. In this manner, both the scalar and the vector components of a context environment and that context environment as time passes may be computed and stored for provision to a simulation environment 26.

Turning now to the hot path data store 10, various logical partitions are also contemplated. For instance, the hot path data store 10 comprises hot path variable correlations database 22. A hot path variable correlations database 22 may comprise representations of a function linking the dependent variables associated with the dependent variable set seeds 16 to the independent variables, but may be provisioned to provide correlations associated with data streams that change frequently during a simulation or which change responsive to feedback from the simulation environment 26. For instance, the hot path variable correlations database 22 may comprise the correlations relating dependent variables to independent variables and feedback structures present in a context environment. Thus, one may appreciate that the combination of dependent variable set seeds 16 with hot path variable correlations data, for example, hot path variable correlations data from the hot path variable correlations database 22, and moreover, with the outputs of the simulation environment 26 may provide feedback responsive dependent variables reposed in a feedback responsive dependent variables set 24.

A feedback responsive dependent variables set 24 comprises a database of values of dependent variables over time, properly correlated to the independent variables of the context environment and to the feedback effects of the output of the simulation environment 26 in response to the transfer function of the simulation environment 26. In this manner, both the scalar and the vector components of a context environment and that context environment as time passes may be computed and stored for provision to a simulation environment 26 based on previous operation of the simulation environment 26 and/or may be computed and adjusted and provided in real-time during runtime based on the output data emerging from a particular simulation running in the simulation environment 26.

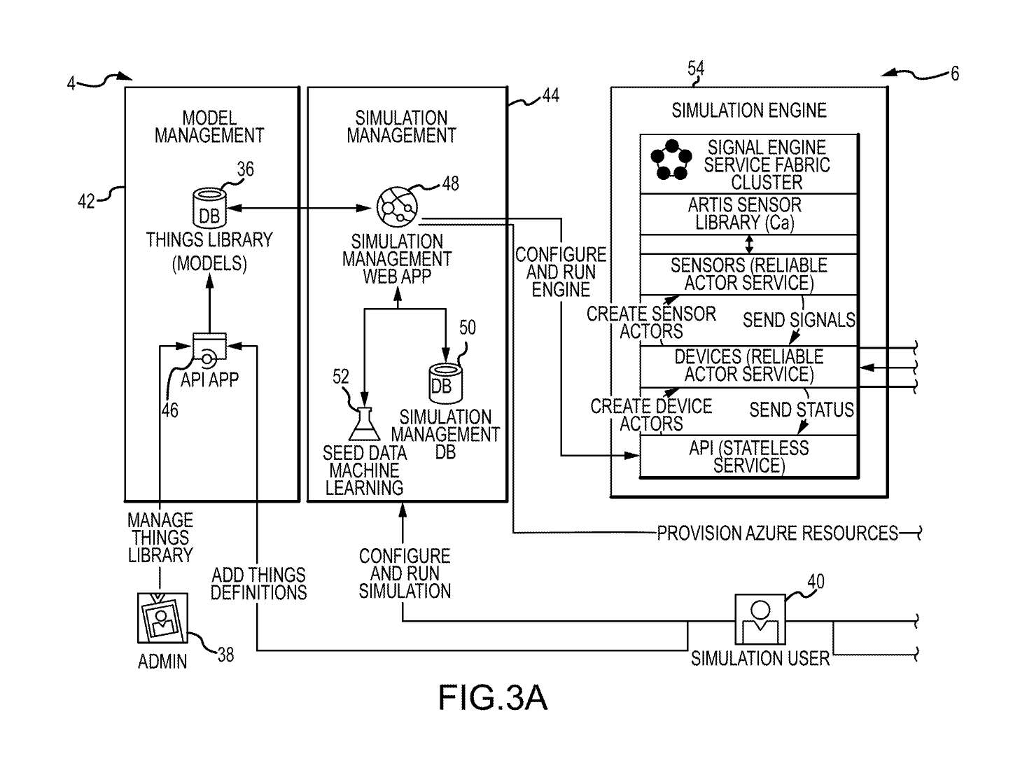

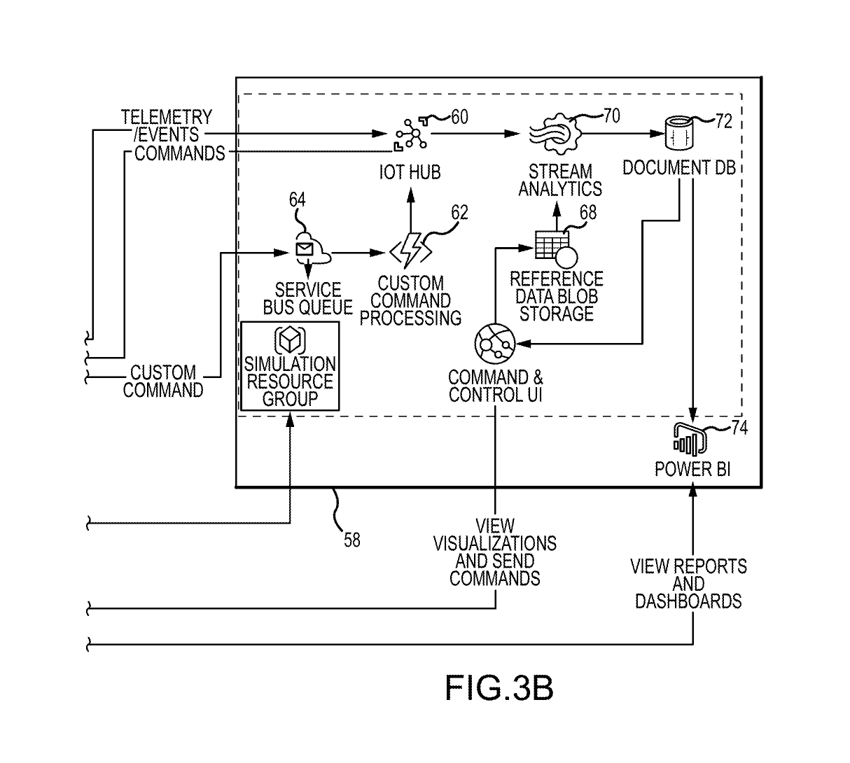

A parameterized descriptor set 21 may further be provided. A parameterized descriptor set may provide one or more parameterized descriptor configured to flow through the hot path data store 10. In various instances, the parameterized descriptors interoperate with the other data, such as dependent variables and independent variables to establish thresholds, alerts, and other actions, such as are discussed elsewhere herein and particularly with reference to the stream analytics engine 70 (FIG. 3A-B) Similarly, the parameterized descriptor set 21 may provide one or more parameterized descriptor configured to flow through the cold path data store such as to document compliance with thresholds, alerts, and other actions, and/or to prove compliance in association with an audit. While a parameterized descriptor set 21 is depicted separately herein, one may appreciate that the parameterized descriptor set 21 may be all or in part a portion of other aspects depicted in FIG. 1 and in further instances, depicted in FIG. 3A-B, as desired. In other words, the IoT device signal simulation system may include a context environment modeling platform with a parameterized descriptors set associated with an electronic representative model.

Continuing in reference to FIG. 1, but with primary reference shifted to FIG. 2, the reliable actor instantiation system 100 may be provided to instantiate logical representations of devices, sensors, and aspects of an IoT system according to defined profiles, wherein the devices, sensors, and aspects of the IoT system are producible at massive scale with little processor and bandwidth demand. For instance, a context environment modeling platform 4 may comprise the reliable actor instantiation system 100 which creates the simulated devices sensors and aspects of the IoT system operating in a context environment. The reliable actor instantiation system 100 may comprise a setup collection 102 a runtime collection 104, and a reliable actor model database 106.

The setup collection 102 may comprise a grouping of components configured to instantiate a desired number and type of reliable actors into a reliable actor set 107. The runtime collection 104 may comprise a grouping of components configured to improve the operation of instantiated reliable actors during runtime of the reliable actors in a simulation environment 26 (FIG. 1). Finally, a reliable actor model database 106 may comprise a repository of reliable actors capable of being instantiated and may be changed and improved over time based on the operation of both the setup collection 102 and the runtime collection 104.

More specifically, the set up collection may comprise a reliable actor model 101 loaded from a reliable actor model database 106. The reliable actor model 101 may comprise a set of inputs, data types expected at inputs, state machines, transfer functions and outputs linked to the inputs via the state machines and transfer functions, such that a model of a device, sensor or other hardware item may be electronically simulated. The reliable actor model 101 is fed into the reliable actor instantiator 108 along with user provided data including a quantity input 103 comprising the number of reliable actors desired to be instantiated based on the reliable actor model 101 and customization input 105 comprising customizations (e.g., changes) to the reliable actor model 101 desired based on a given context environment. For instance, a reliable actor modeling a common temperature sensor may be instantiated but a customization input 105 may provide that for a subset of such instantiated reliable actors, premature wear due to a manufacturing defect may be modeled so that the simulation environment 26 accounts for potential failures in a context environment. This premature wear may be distributed along a probabilistic curve, such as provided by a customization input 105 and thus more closely following real world behavior. This distribution may also be sourced from the reliable actor model database 106 and based on machine learning during the running of the simulation environment 26 as collected by the machine learning supervisor 28 (See FIG. 1).

As such a reliable actor set 107 is created by the setup collection 102 and accessed as a part of the runtime collection 104. The reliable actor set 107 may further comprise feedback data provided by a feedback mapper 110 configured to map various feedback variables traveling in a hot path data store 10 to various reliable actors such that the real world responsiveness of the reliable actors to hot path data is emulated. Finally, an expected input data stream 109 is sourced from both cold path data store 8 and hot path data store 10. Thus one may appreciate that with reference to FIG. 1, in various instances the reliable actor instantiation system 100, though defined within the context environment modeling platform 4, may extend to and comprise a further aspect of a simulation environment 26, having aspects operable during run time of a simulation, and further responsive to contextual customization variables source 12 and machine learning.

Moving on now to FIG. 3A-B, a specific implementation of an IoT device signal simulation system 2 is depicted. However, ongoing reference is further extended to FIGS. 1 and 2 as aspects of the context environment modeling platform 4, simulation execution platform 6 and reliable actor instantiation system 100 will be understood to be subsumed within the logical units of the system according to FIG. 3A-B. One may appreciate that while different reference numbers may be used, the features, aspects and characteristics as described with reference to FIGS. 1 and 2 also refer to like features, aspects, and characteristics one having ordinary skill in the art would recognize as a part of the system according to FIG. 3A-B. As one may appreciate, there is not necessarily a one-to-one mapping of features, aspects, and characteristics as described with reference to FIGS. 1 and 2 to the elements of the system according to FIG. 3A-B, but rather the features, aspects, and characteristics may be distributed across one or more of the elements of the system according to FIG. 3A-B, rather than being mapped one-to-one to an element of the system according to FIG. 3A-B.

With reference to FIG. 3A-B, a context environment modeling platform 4 and a simulation execution platform 6 as discussed are provided. In various instances, the context environment modeling platform 4 may be logically partitioned in to two subsystems. For example, a context environment modeling platform 4 may include a model management logical partition 42 and a simulation management logical partition 44.

In various embodiments, a model management logical partition 42 may comprise a set of structures configured to manage stored models of sensors, devices, and other IoT hardware whereby a reliable actor instantiation system 100 (FIG. 2) may reliably and consistently instantiate emulations of devices sensors, and IoT hardware according to previously stored models thereof. Such model may include transfer functions, data types and enumerations, state machines, variable data such as hot path variable data and cold path variable data, and other aspects as desired. Thus, the model management logical partition 42 may comprise a things library 36 comprising a repository of previously stored models of devices, sensors, and IoT hardware. In various instances, the things library 36 may comprise a crowd sourced repository, or may comprise a repository of previously used models, or may comprise models provided by device manufacturers, or may comprise any source of reposed models. One may appreciate that aspects of the cold path data store 8, hot path data store 10, contextual customization variables source 12, machine learning supervisor 28, and reliable actor instantiation system 100 may comprise aspects of the things library 36. In further embodiments, aspects of the simulation environment 26 may be reposed within the things library 36. One may also appreciate that the system will provide concurrent support for at least one continuous variables stream and for discrete events, wherein a state machine associates the discrete events with the at least one continuous variables streams.

The model management logical partition 42 may further comprise a model management API 46. The model management API 46 may be configured to receive inputs from a simulation user 40 as well as an administrator 38 corresponding to instructions to the things library 36 such as to create, delete, or modify data in the things library 36.

While a simulation user 40 and an administrator 38 are both illustrated herein, it is envisioned that a person, system, or account identified as a simulation user 40 may interact with the system 2 to generate reports and so-called “dashboard(s)” as referenced elsewhere herein such that a visual display may be shown to a consumer. For instance, a simulation user 40 may create a use case scenario, and generate a dashboard 74 for a user other than a simulation user 40. In various instances, one or more of the simulation user 40, administrator 38, and end user (e.g., user other than a simulation user and for which a dashboard is generated) may be different roles associated with the same individual or entity or account, whereas in further instances one or more may be associated with differing individuals or entities or accounts.

Using the model management API 46, one may create a model of an individual device/sensor. For instance, one may enumerate the relation of devices in the things library 36, enumerate signals and commands for each device, and define aspects of a context environment sensed or effected by the device/sensor, as well as messages into and out of the sensor. In this manner, the model management API 46 may be leveraged to create in the things library 36 a repository of devices or sensors that once modeled, can be reused.

The simulation management logical partition 44 may comprise a set of structures configured to manage simulations to be run by the simulation execution platform 6, whereby reliable actors emulating devices, sensors, and other IoT hardware may be positioned within a context environment and operated. The simulation management logical partition 44 may instantiate a cluster of devices/sensors of a chosen size and composition based on devices/sensors in the things library 36 and may enumerate each of the things in a simulation. By building only one simulated thing but instantiating multiple independent instances, the processor and memory demands of the simulation may be ameliorated and network bandwidth and processor load managed. The simulation management logical partition 44 may include a simulation management interface 48 configured to ingest models from a things library 36 and further to apply the simulation to the models. For instance, a simulation management database 50 may provide a simulation and a seed data machine learning engine 52 may provide data based on previous behavior of simulations whereby a plurality of models instantiated from the things library 36 are combined with a context environment for running by a simulation environment 26 of a simulation execution platform 6. The seed data machine learning engine 52 may evolve or may change, ab initio, the attributes of one or more device/sensor according to a statistical model. In this manner, an array of standard devices or sensors from the things library may be tweaked such as to contemplate a mean-time-before-failure, and then designate different devices/sensors to fail at different times according to an expected distribution of failures associated with the mean.

In various instances, a user may utilize the simulation management interface 48 to tailor attributes of a model from the things library 36 in order to evaluate the effect of such tailoring on the behavior of the device, sensor, or a larger system.

As mentioned, the IoT device signal simulation system 2 may comprise simulation execution platform 6 in addition to the context environment modeling platform 4. In various instances, the simulation execution platform 6 comprises a simulation environment 26 as discussed with reference to FIG. 1. The simulation environment 26 may include both a simulation client instance 58 and a simulation engine 54.

In various instances, a simulation engine 54 comprises a processor and non-transient computer readable medium operable to apply the instantiated models within the parameters of a simulation to emulate a complete context environment, including an IoT system.

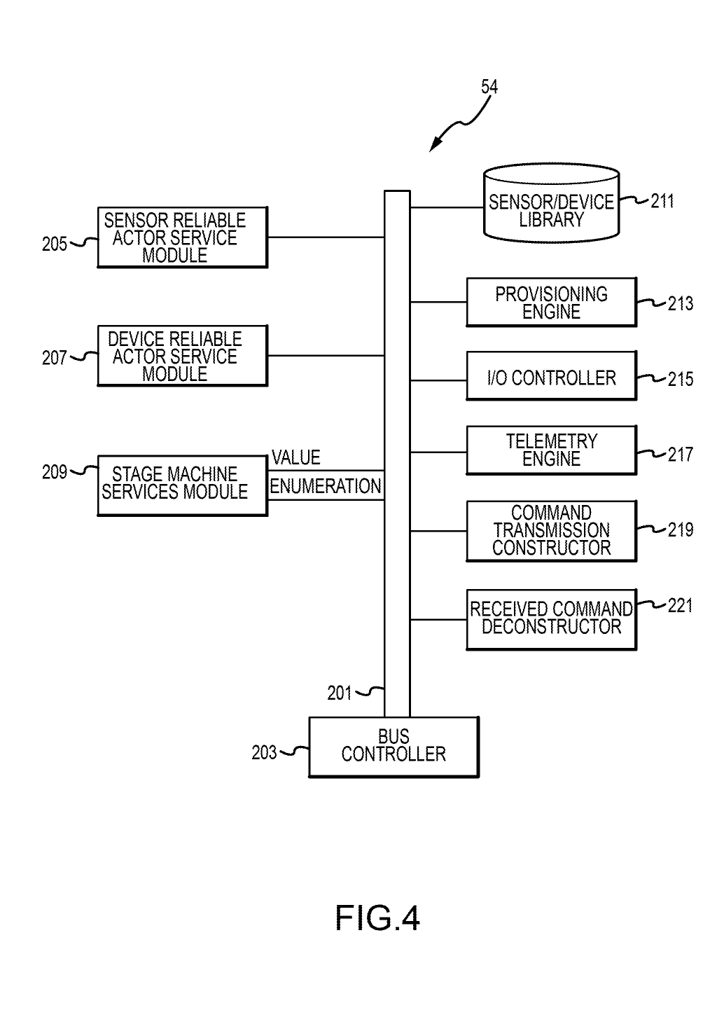

The simulation engine 54 may include a variety of sub components to facilitate such operation. For example, with reference to FIGS. 1-3, but also reference to FIG. 4, a simulation engine 54 is discussed in further detail.

In various instances, the simulation engine 54 may include a library of sensors that interoperates with a plurality of sensors modeled by a reliable actor service. Sensors may be associated with devices, also modeled by a reliable actor service and any device may include plurality of sensors. A stateless service, for instance, an API may be operable to create device actors. The device actors may be operable to provide status data to the stateless service. The devices may each be operable to create sensor actors. Each sensor may be operable to send signals to the device actor. Finally the sensor library may comprise a body of commands and features implemented by each sensor such that signals created by the sensors are responsive to various data. In this manner, the simulation engine 54 may be configured to handle simulations with many instances of many devices each having many sensors, but through modular architecture and the implementation of both cold path data stores 8 and hot path data stores 10 (along with contextual customization variables source 12), bandwidth and processor load during runtime may be significantly ameliorated.

Specifically, the simulation engine 54 may comprise a simulation engine bus 201. A simulation engine bus 201 may comprise a hardware bus connecting the various controllers, modules, libraries, engines, and other aspects of the simulation engine 54. In further instances, the simulation engine bus 201 comprises a logical bus.

The simulation engine 54 may comprise a simulation engine bus controller 203. The simulation engine bus controller 203 comprises a controller configured to direct the interoperation of the modules, libraries, engines, and other aspects of the simulation engine 54 via the simulation engine bus 201. The simulation engine bus controller 203 may control the transmission and reception of data internally among items interconnected to the bus, as well as supervising communication with external resources.

The simulation engine 54 may comprise a sensor reliable actor service module 205. The sensor reliable actor service module 205 is configured to instantiate sensors via a reliable actor instantiation system 100 and is further configured to send signals generated by instantiated sensors to a device reliable actor service module 207 for further utilization.

The simulation engine 54 may comprise a device reliable actor service module 207. The device reliable actor service module 207 is configured to instantiate devices via a reliable actor instantiation system 100 and is further configured to send signals generated by the instantiated sensors as well as to send data representative of device status to a state machine service module 209. The device reliable actor service module 207 is further configured to transmit telemetry/event data to external resources off the bus via the telemetry engine 217. Furthermore, the device reliable actor service module 207 is configured to transmit customized commands based on contextual customization variables source 12 data associated with a device or sensor instantiated by the reliable actor instantiation system 100 via a command transmission constructor 219.

The simulation engine 54 may comprise a state machine service module 209. The state machine service module 209 may direct the operation of both devices and sensors, such as by directing the operation of the device reliable actor service module 207 and the sensor reliable actor service module 205. By ingesting data including scalar values, vector values, and enumerated types from the device reliable actor service module 207 and the sensor reliable actor service module 205, the state machine service module 209 may trigger state transitions for each device or sensor so modeled. For example, during an “off state” of a sensor, the state machine service module 209 may ignore instructions to that sensor, refusing to pass the instructions to the device reliable actor service module 207 and the sensor reliable actor service module 205, thereby ameliorating processor and bandwidth limitations by blocking such instructions from further access to the simulation engine bus 201.

As depicted in FIG. 4, the state machine service module 209 may comprise two connections to the simulation engine bus 201. For instance, a variable such as a variable associated with a cold path data store 8 or hot path data store 10 (FIG. 1) may have both a value and may also be associated with a particular state, whether of a device or of a sensor. As such, the state machine service module 209 may be configured to provide both variable values via a value path and also an enumeration of a state associated with the value of the variable via an enumeration path.

The simulation engine 54 may comprise a sensor/device library 211. The sensor/device library 211 may be analogous to the things library 36, although in further instances, the sensor/device library 211 comprises a cache of at least a subset of the things library 36. For instance, the sensor/device library 211 may catalog the inputs, outputs, transfer functions, state machines, and/or the like associated with each device and/or sensor, thereby enabling the state machine service module 209, the device reliable actor service module 207 and the sensor reliable actor service module 205 to ascribe proper handling to various datum of various type and direct various datum of various type to proper destinations via the simulation engine bus 201.

The simulation engine 54 may comprise a provisioning engine 213. A provisioning engine 213 may operate in cooperation with a reliable actor instantiation system 100 to transmit a call to the reliable actor instantiation system 100 via an I/O controller 215 to instantiate a device, sensor, and or the like for use by the simulation engine 54.

The simulation engine 54 may comprise an I/O controller 215. As discussed elsewhere herein, the I/O controller 215 provides a gatekeeping function for data received into the simulation engine bus 201 and transmitted out from the simulation engine bus 201. In this manner, the I/O controller 215 provides for improved security and isolation among aspects of the simulation engine 54, facilitating improved resilience and ameliorating bandwidth and processor load associated with unwanted or misdirected communication.

The simulation engine 54 may comprise a telemetry engine 217. The telemetry engine 217 interoperates with the device reliable actor service module 207 to format signals from instantiated devices for delivery by the I/O controller 215 to a particular external resource external to the simulation engine 54, such as an IoT hub 60 of a simulation client instance 58 of a simulation environment 26, which will be discussed further with respect to FIG. 3A-B below. In various instances, different external resources external to the simulation engine 54 require differently formatted telemetry, thus, the telemetry engine 217 is also interoperable with the provisioning engine 213 which is configured to instruct the telemetry engine 217 with respect to the proper formatting of the telemetry.

The simulation engine 54 may comprise a command transmission constructor 219. The command transmission constructor 219 interoperates with the device reliable actor service module 207 to format instructions from instantiated devices for delivery by the I/O controller 215 to a particular external resource external to the simulation engine 54 and capable of receiving operating instructions therefrom, such as a service bus queue 64 of a simulation client instance 58 of a simulation environment 26. In various instances, different external resources external to the simulation engine 54 require differently formatted signals, thus, the command transmission constructor 219 is also interoperable with the provisioning engine 213 which is configured to instruct the command transmission constructor 219 with respect to the proper formatting of the commands.

The simulation engine 54 may comprise a received command deconstructor 221. A command deconstructor interoperates with the device reliable actor service module 207 to format instructions received from external resources external to the simulation engine 54, such as an IoT hub 60 and enroute to a device reliable actor service module 207. The received command deconstructor 221 receives various differently formatted signals, and interoperating with the provisioning engine 213, is instructed with respect to the proper formatting of the commands.

Returning attention primarily to FIGS. 1 and 3, having completed the discussion of the simulation engine 54 and aspects thereof, attention is now directed to another aspect of the simulation environment 26. The simulation environment 26 may comprise a simulation client instance 58, which also may comprise further aspects.

A simulation client instance 58 may comprise an IoT hub 60. While in various embodiments an IoT hub 60 may comprise a simulated gateway device processing and channeling data to and from an array of actual or simulated IoT devices/sensors, in further embodiments, an IoT hub 60 may comprise a physical gateway device processing and channeling data to and from an array of actual or simulated IoT devices/sensors. For example, an IoT hub 60 may comprise a hub of an actual internet-of-things network. Thus, one may appreciate that the simulation and virtualization aspects discussed herein may be configured to interoperate with actual IoT networks, such as to provide data to the IoT hub 60 that is consistent with the data that the IoT hub 60 would actually expect from a simulated array of IoT devices/sensors. In this manner, proper operation of the IoT hub 60 when configured in a network of an intended number, nature, and type of IoT devices/sensors in a context environment, can be simulated.

In addition, the simulation client instance 58 may comprise a service bus queue 64. A service bus queue 64 may receive commends from the simulation engine 54 destined for the IoT hub 60. For instance, the simulation engine 54 may be simulating one or more device/sensor that would be in communication with the IoT hub 60 in a practical implementation. In various instances, such device/sensor may provide commands to the IoT hub 60 such as in connection with data from the device/sensor needing to be received and processed by the IoT hub 60. In various instances, the service bus queue 64 provides a buffer for receipt and holding of such commands before passing them to a custom command processor 62 in route to the IoT hub 60.

Moreover, the simulation client instance 58 may comprise a custom command processor 62. A custom command processor 62 is configured to receive commands from the service bus queue 64 and adjust the syntax of the commands to correspond to the parameters of the transmission protocol of a given IoT hub 60. In this manner, a variety of different types of IoT hubs 60 may be contemplated.

Additionally, the simulation client instance 58 may comprise a command and control user interface 66. A command and control user interface 66 comprises a user-facing mechanism for transmitting operative instructions regarding the functioning of the simulation client instance 58, such as to direct the preparation of different reports, different graphs and visualizations, and to insert commands for forwarding to aspects of the system, including the simulation client instance 58.

Moreover, there may be a reference data storage 68 within the simulation client instance 58. Reference data storage 68 may comprise a non-transient computer readable memory configured to receive commands from the command and control user interface 66 and lodge them for utilization by the simulation client instance 58 at desired times. In various instances, the reference data storage 68 is considered a portion of the cold path aspect, as discussed previously.

Yet further, the simulation client instance 58 may comprise a stream analytics engine 70. A stream analytics engine 70 may receive data flowing into and out of the IoT hub 60 and may perform diagnostic analysis on the data for display to a user. For instance, the data flowing into and out of the IoT hub 60 may be, in various instances, considered to be a portion of the hot path aspect as previously discussed. The data may be sampled by the stream analytics engine 70 in order to prepare visualizations for display to a user. The stream analytics engine 70 may apply thresholds to the data, or may trigger alerts based on the data. The stream analytics engine 70 may evaluate hot path data according to rules such as thresholds or alert triggers and may apply thresholds to the data or may trigger alerts based on the data. Moreover, the stream analytics engine 70 may be operable to apply rules each time a data stream is received. In further instances, the stream analytics engine 70 may interoperate with other aspects of the system so that the rules are not applied by the stream analytics engine 70 but are embedded in a part of the model and analytic outcomes of the application of the already present rule may be extracted by the stream analytics engine 70. In yet further instances, the stream analytics engine 70 may combine aspects of both approaches, such as extracting an outcome of an already present rule and/or tweaking the application of a rule such as applying a correction factor to the rule and evaluating the hot path data according to the corrected rule such a threshold or alert trigger. Furthermore, the stream analytics engine 70 may facilitate machine learning, such as to improve data quality through automated modifications to rules, correction factors, thresholds, alert triggers, and the like. In various instances, a stream analytics engine 70 may store all or a portion of the data, or all or portion of the result of the application of the thresholds or alerts to the data in the document database 72.

In addition, the simulation client instance 58 may include a document database 72. A document database 72 may receive data from the stream analytics engine 70 and may store it for future reference. The document database 72 may also forward this data to the command and control user interface 66 for display to the user and/or forwarding by the command and control user interface 66 to other system aspects. Furthermore the document database 72 may forward this data to the dashboard 74, such as for further display to the user. In various instances, the document database 72 records data to facilitate replay of simulations. From time to time, model heuristics compel a plurality of unscripted paths from one simulation to another. From time to time, there may be a need to replay one such unscripted path from among a plurality thereof, such as by retrieving data from the document database 72.

Finally, the simulation client instance 58 may comprise a dashboard 74. A dashboard 74 comprises a user configurable visual display of different data representative of the operation of aspects of the disclosure herein.

As used herein “controller” or “processor” mean any device capable of receiving and/or processing an electronic message, such as a computer or processor, or a set of computers/processors, although other types of computing units or systems may be used, including laptops, notebooks, hand held computers, personal digital assistants, cellular phones, smart phones (e.g., iPhone®, BlackBerry®, Android®, etc.) tablets, wearables (e.g., smart watches and smart glasses), or the like.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptography systems.

In various embodiments, storage aspects, such as memories may be local, while in further embodiments, they may be distributed. Moreover, both local and distributed storage aspects may interact with third-party storage aspects, and may be configured for storage and/or processing of big data sets. As used herein, big data may refer to partially or fully structured, semi-structured, or unstructured data sets including millions of rows and hundreds of thousands of columns. A big data set may be compiled, for example, from a history over time, from web registrations, from social media, from internal data, or from other suitable sources. Big data sets may be compiled with or without descriptive metadata such as column types, counts, percentiles, or other interpretive-aid data points.

In various embodiments, individual aspects represented in the figures may comprise a plurality of nodes. Nodes may comprise same or similar computers or processors which may be distributed geographically in different locations, housed in the same building, and/or housed in the same rack. Nodes may also be configured to function in concert to provide storage space and/or processing power greater than one of a node might provide alone. Data may be collected by nodes individually and compiled or in concert and collated. Data may further be compiled into a data set and formatted for use.

In various embodiments, data may be collected from multiple sources and amalgamated into a big data structure such as a file, for example. In that regard, the data may be used as an input to generate metadata describing the big data structure itself, as well as the data stored in the structure.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YouTube®, AppleTV®, Pandora®, xBox®, Sony® Playstation®), a uniform resource locator (“URL”), a document (e.g., a Microsoft Word® document, a Microsoft Excel® document, an Adobe .pdf document, etc.), an “ebook,” an “emagazine,” an application or microapplication (as described herein), an SMS or other type of text message, an email, Facebook, twitter, MMS and/or other type of communication technology. In various embodiments, a channel may be hosted or provided by a data partner. In various embodiments, the channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and/or a mobile device communication. Examples of social media sites include Facebook®, Foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. As those skilled in the art will appreciate, user computer may include an operating system (e.g., Windows NT®, Windows 95/98/2000®, Windows XP®, Windows Vista®, Windows 7®, OS2, UNIX®, Linux®, Solaris®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, and optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://dx.doi.org/10.6028/NIST.SP.800-145 (last visited August 2017), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An IoT device signal simulation system comprising:
a context environment modeling platform configured to develop an electronic representative model of a plurality of sensor inputs to simulated sensors associated with a simulated device in a context environment;
a simulation execution platform configured to develop an electronic representative model of an operating IoT system ingesting the plurality of sensor inputs and creating a plurality device outputs associated with the simulated device in the context environment; and
a reliable actor instantiation system operative to generate the electronic representative models in response to at least one of the context environment modeling platform and the simulation execution platform.

2. The IoT device signal simulation system according to claim 1, wherein the system further provides concurrent support for at least one continuous variables stream and for discrete events, wherein a state machine associates the discrete events with the at least one continuous variables streams.

3. The IoT device signal simulation system according to claim 1, wherein the system is configured to generate responsive data based on a combination of the electronic representative model of the device and device outputs associated with the device in the context environment.

4. The IoT device signal simulation system according to claim 3, wherein the context environment modeling platform comprises a parameterized descriptors set associated with the electronic representative model.

5. The IoT device signal simulation system according to claim 1, wherein the context environment modeling platform comprises a cold path data store and a hot path data store, the cold path data store comprising a repository of a portion of the plurality of sensor inputs and the hot path data store comprising a repository of a further portion of the plurality of sensor inputs that change simultaneously with the creating the device outputs associated with the device in the context environment.

6. The IoT device signal simulation system according to claim 5, wherein the portion of the sensor inputs of the cold path data store is asynchronously generated by the context environment modeling platform before the creating the device outputs associated with the device in the context environment.

7. The IoT device signal simulation system according to claim 6, wherein the context environment modeling platform comprises a contextual customization variables source comprising user variable input data streams changeable simultaneously with the creating the device outputs associated with the device in the context environment

8. The IoT device signal simulation system according to claim 5, wherein the cold path data store comprises independent variable set seeds, wherein each independent variable set seed comprises an array of values associated with expected variable values of an independent variable of the context environment, wherein the array of values are not responsive to an operation of the IoT system.

9. The IoT device signal simulation system according to claim 8, wherein the cold path data store comprises dependent variable set seeds, wherein each dependent variable set seed comprises an array of values associated with a dependent variable of the context environment that is responsive to the independent variable.

10. The IoT device simulation system according to claim 9, wherein the cold path data store comprises a cold path variable correlations database comprising functions linking the independent variables to further dependent variables associated with the dependent variable set seeds and not responsive to the operation of the IoT system.

11. The IoT device simulation system according to claim 10, wherein the cold path data store comprises a dependent variable set database comprising a database of values of the dependent variables associated with the dependent variable set seeds and responsive to the operation of the IoT system.

12. The IoT device simulation system according to claim 11, wherein the hot path data store comprises a hot path variable correlations database comprising functions linking the independent variables to dependent variables associated with the dependent variable set seeds and responsive to the operation of the IoT system.

13. The IoT device simulation system according to claim 12, wherein the hot path data store comprises a feedback responsive dependent variables set comprising a database of values of dependent variables responsive to the operation of the IoT system.

14. The IoT device simulation system according to claim 12, further comprising a parameterized descriptor set configured to provide one or more parameterized descriptor from the hot path data store to the cold path data store to create at least a portion of at least one dependent variable.

15. An IoT device simulation system comprising:
a context environment modeling platform configured to develop an electronic representative model of a plurality of sensor inputs to sensors associated with a device in a context environment, wherein the context environment modeling platform comprises:
a model management partition comprising a things library including a cloud-sourced repository of at least one a device model of a device and a sensor model of a sensor; and
a simulation management partition including a simulation management database to provide a simulation;
a simulation execution platform configured to develop an electronic representative model of an operating IoT system including at least one of the device and the sensor, the simulation execution platform ingesting the sensor inputs and creating device outputs associated with the at least one of the device and the sensor in the context environment responsive to the simulation; and
a reliable actor instantiation system operative to generate the electronic representative models in response to at least one of the context environment modeling platform and the simulation execution platform.

16. The IoT device simulation system according to claim 15, wherein the reliable actor instantiation system instantiates at least one of the device model and the sensor model in response to a model management API.

17. The IoT device simulation system according to claim 16, wherein the simulation management partition comprises a seed data machine learning engine to provide historical simulation data based on previous behavior of the simulation and modify the simulation responsive to the historical simulation data.

18. The IoT device simulation system according to claim 17, wherein the simulation execution platform comprises a simulation environment including a simulation client instance and a simulation engine configured to apply a plurality of instantiated models based on the model and within a parameter of the simulation to emulate a context environment.

19. The IoT device simulation system according to claim 18, wherein the simulation engine comprises a sensor reliable actor service module configured to instantiate sensors via a reliable actor instantiation system;
a device reliable actor service module configured to instantiate devices via the reliable actor instantiation system and to send signals generated by the sensors and data representative of a device status to a state machine service module via a simulation engine bus;
a provisioning engine operable to transmit a call to the reliable actor instantiation system via an I/O controller connected to the simulation engine bus, the call comprising an instruction to instantiate the devices or the sensors;
a state machine service module configured to direct an operation of the device reliable actor service module and the sensor reliable actor service module comprising triggering state transitions for at least one of the devices and the sensors in response to the signals and the device status, wherein, in response to the state transition indicating an off state of at least one of the sensors, the state machine service module blocks data to the at least one of the sensors from the simulation engine bus; and
a telemetry engine connected to the device reliable actor service module via the simulation engine bus and configured to format a signal from at least one of the devices and the sensors for delivery to an IoT hub of a simulation client instance of a simulation environment; and
a stream analytics engine configured to capture data between (a) at least one of (i) the at least one of the devices and (ii) the at least one of the sensors and (b) the IoT hub of the simulation client instance of the simulation environment, the stream analytics engine further configured to create a user readable visualization of the data.

20. A simulation engine comprising:
a sensor reliable actor service module configured to instantiate sensors via a reliable actor instantiation system;
a device reliable actor service module configured to instantiate devices via the reliable actor instantiation system and to send signals generated by the instantiated sensors and data representative of a device status to a state machine service module via a simulation engine bus;
a provisioning engine operable to transmit a call to the reliable actor instantiation system via an I/O controller connected to the simulation engine bus, the call comprising an instruction to instantiate the instantiated devices or the instantiated sensors;
a state machine service module configured to direct an operation of the device reliable actor service module and the sensor reliable actor service module comprising triggering state transitions for at least one of the instantiated devices and the instantiated sensors in response to the signals and the device status, wherein, in response to the state transition indicating an off state of at least one of the instantiated sensors, the state machine service module blocks data to the at least one of the instantiated sensors from the simulation engine bus; and
a telemetry engine connected to the device reliable actor service module via the simulation engine bus and configured to format a signal from at least one of the instantiated devices and the instantiated sensors for delivery to an IoT hub of a simulation client instance of a simulation environment; and
a stream analytics engine configured to capture data between at least one of the at least one of the instantiated devices and the at least one of the instantiated sensors and the IoT hub of the simulation client instance of the simulation environment and create a user readable visualization of the data.
